(19) United States
(12) Patent Application Publication
(10) Pub. No.: US 2010/0126242 A1
(43) Pub. Date: May 27, 2010

(54) Tool for Opening a Split Ring Key Holder

(76) Inventors: Thomas Perlmutter, Calabasas, CA (US); Robert Lloyd Lewis, Calabasas, CA (US)

Correspondence Address: GORDON & JACOBSON, P.C., 60 LONG RIDGE ROAD, SUITE 407, STAMFORD, CT, 06902, US

(21) Appl. No.: 12/276,514

(22) Filed: Nov. 24, 2008

(51) Int. Cl. E05B 19/00

(52) U.S. Cl. 70/456 R

(57) ABSTRACT

A tool for connecting items to and from a split ring key holder. The tool includes a blade having a distal end opposite a proximal end with an intermediate portion therebetween. The distal end has a generally wedge shape with a narrow distal tip. The intermediate portion has first and second scalloped edges on opposite sides of the intermediate portion. The first and second scalloped edges define respective sequences of peaks and valleys opposed to one another. The narrow distal tip of the distal end of the blade and the first and second scalloped edges of the intermediate portion of the blade are adapted to separate and spread apart the split ring key holder. In the preferred embodiment, the blade is retractable and housed within a housing that provides for translation of the blade along a predetermined translation axis.

### BACKGROUND OF THE INVENTION

1. Field of the Invention

This invention relates to devices for opening a split ring key holder.

2. State of the Art

Split ring key holders are commonly used to carry a set of keys and other small-size personal items such as charms, USB memory sticks, micro-sized credit cards and courtesy cards for transactions, tools such as knives and clipper, etc. These items typically have a through-hole at one end that is threaded onto the split key ring. A split ring key holder is commonly realized by a tight spiral member of spring steel or equivalent plastic material, which extends through one complete helical turn and a fraction of a second helical turn.

In order to thread a key onto the split ring key holder (also referred to as a slit ring), the user must spread one end of the spiral member away from the intermediate portion of the spiral member and insert the free end of the spiral member through the through-hole of the key. In this configuration, the free end portion of the spiral member passes through the through-hole of the key, while the intermediate portion and other end portion of the spiral member lie outside the through-hole of the key. The key is then moved around the split ring beyond the other end of the spiral member such that the entire cross-section of the spiral member rests inside the through-hole of the key. In this configuration, the split ring supports this key along with other keys that have been threaded thereon, if any. Similar actions are carried out to thread other items onto the split ring.

In order to remove a key from the split ring, the user must spread one end of the spiral member away from the intermediate portion of the spiral member and remove this free end of spiral member from the through-hole of the key. In this configuration, the free end portion of the spiral member passes outside the through-hole of the key, while the intermediate portion and other end portion of the spiral member lie inside the through-hole of the key. The key is then moved around the split ring beyond the other end of the spiral member such that the entire cross-section of the spiral member rests outside the through-hole of the key. In this configuration, the key is separated from the split ring such that it is not supported by the split ring. Similar actions are carried out to remove other items from the split ring.

When threading a key onto (or removing a key from) a split ring, the task of spreading the respective end of the spiral member away from the intermediate portion of the spiral member in order to start the threading (or removal) process can be difficult, especially where the split ring supports a near capacity complement of keys and the like and/or where the split ring is made of especially stiffly resilient material and/or where the user has less than average strength or dexterity in his or her hands and/or where the key to be slipped onto or off the ring is a thick relative to the opening created by spreading the end of the spiral member from its intermediate portion.

### SUMMARY OF THE INVENTION

It is therefore an object of the invention to provide a tool (and corresponding method of operation) that simplifies and eases the process of threading a key onto (or removing a key from) a split ring key holder.

In accord with these objects, which will be discussed in detail below, an improved tool is provided for connecting items to and from a split ring key holder. The tool includes a blade member having a distal end opposite a proximal end with an intermediate portion therebetween. The distal end has a generally wedge shape with a narrow distal tip. The intermediate portion has first and second scalloped edges on opposite sides of the intermediate portion. The first and second scalloped edges define respective sequences of peaks and valleys opposed to one another. The narrow distal tip of the distal end of the blade member and the first and second scalloped edges of the intermediate portion of the blade member are adapted to separate and spread apart the split ring key holder. In the preferred embodiment, the blade member is retractable and housed within a housing that provides for translation of the blade member along a predetermined translation axis.

It will be appreciated that the tool of the present invention allows the user to effectively and efficiently separate and spread apart a split ring key holder for connecting and removing items from the split key ring holder. For example, the wedge-shaped distal tip of the retractable blade member slides easily between the adjacent helical sections of the split ring key holder in order to initially separate such helical sections. The scalloped structure of the edges of the blade member allows the user to keep the blade secure while providing the ability to spread ring to any desired opening. The flat surfaces of the scalloped edges employed in the preferred embodiment keeps the blade member in place while the blade is rotated and the helical sections of the split ring key holder is spread. The retractable nature of the blade together with the cap that covers the tool housing allows the blade to be stored in a retracted position while not in use, which provides for safety and limits interference of the tool with other items.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of an exemplary embodiment of a tool in accordance with the present invention.

FIG. 2A is a cutaway view of the top portion of the tool housing of FIG. 1 in accordance with the present invention.

FIG. 2B is a cutaway view of the bottom portion of the tool housing of FIG. 1 in accordance with the present invention.

FIG. 3A is a perspective view of the blade member of the tool of FIG. 1 in accordance with the present invention.

FIG. 3B is a top view of the blade member of FIG. 3A.

FIG. 3C is a side view of the blade member of FIG. 3A.

FIGS. 4A-4E are schematic illustrations of the methodology of using the tool of FIG. 1 to separate and spread apart a key ring holder in accordance with the present invention.

FIGS. 5A and 5B are a top view and side view, respectively, of an exemplary embodiment of the blade member of FIG. 3A, illustrating dimensions of the exemplary blade member.

### DETAILED DESCRIPTION

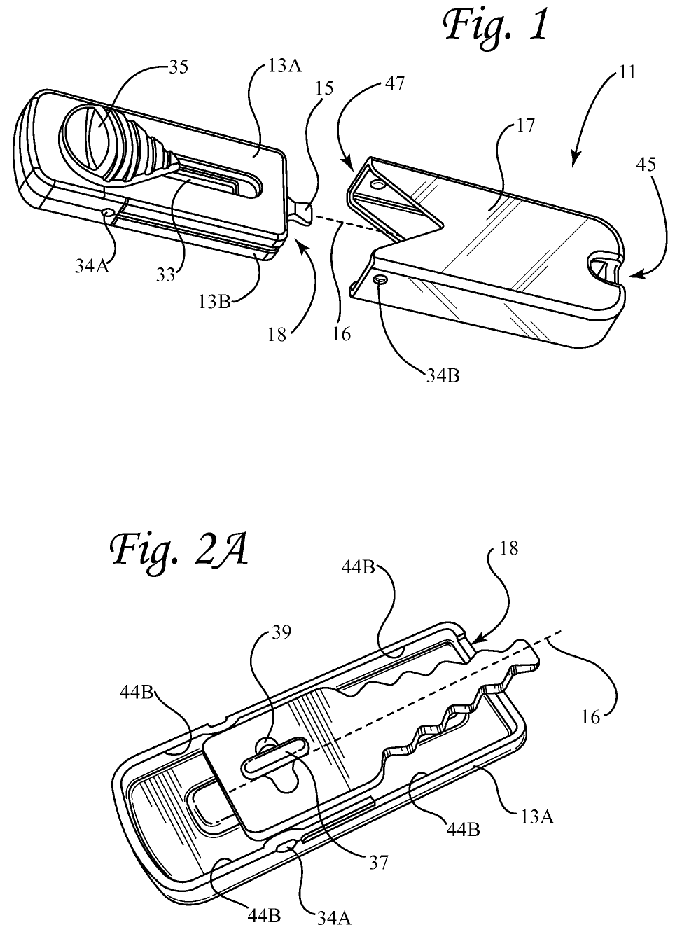

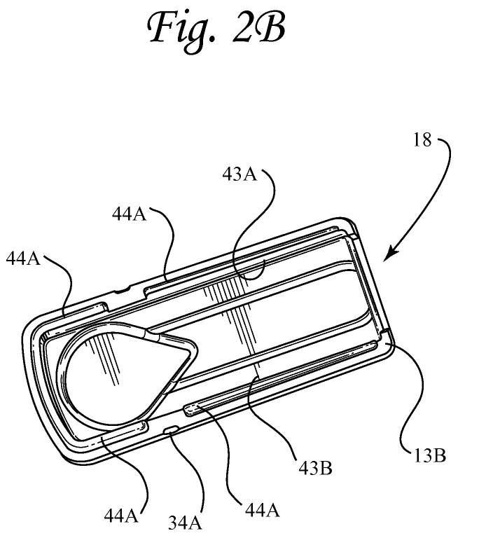

Turning now to FIG. 1, a tool 11 for separating and spreading apart a split ring key holder in accordance with the present invention includes a generally rectangular slim hand-holdable two-part housing 13A, 13B (collectively, housing 13) that supports a retractable blade member 15 therein. In the preferred embodiment, the housing portions 13A, 13B are secured together by wall portions 44A, 44B that interface to one another in a snap-fit manner as best shown in FIGS. 2A and 2B. The blade member 15 translates along a predetermined translation axis 16 extending through an opening 18 in the housing 13 as best shown in the cutaway views of FIG. 2A. The housing 13 is inserted into a cap 17 and secured thereto in a snap-fit manner by recesses 34A formed in the housing 13 that receive corresponding protrusions 34B on the inner surface of the cap 17 as shown. When secured to the housing 13, the cap 17 covers and surrounds a desired portion of the housing 13 and the blade member 15 supported therein as shown.

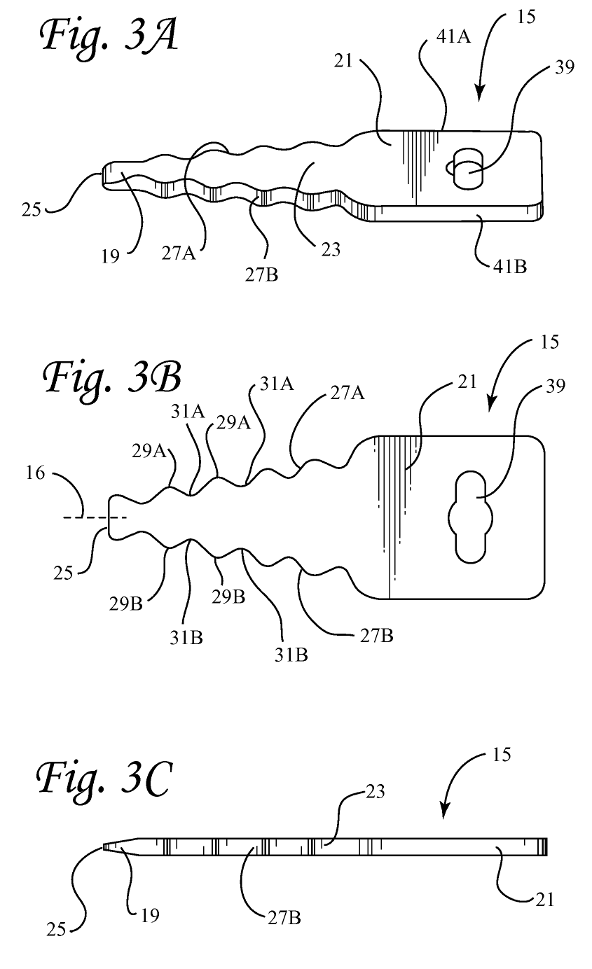

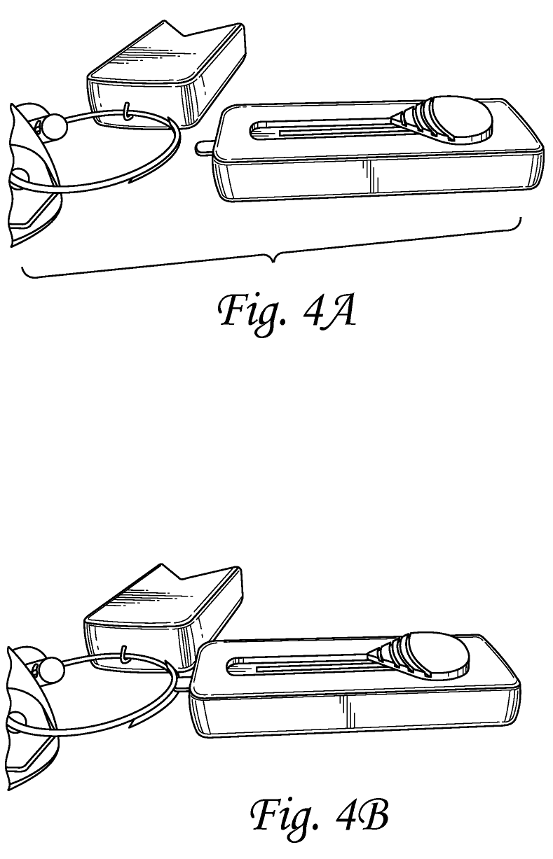

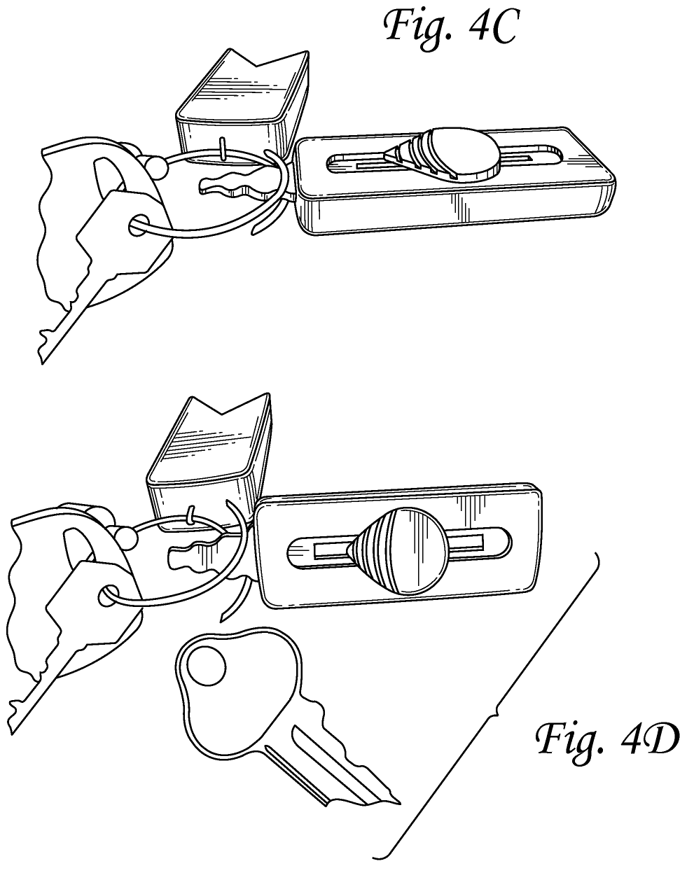

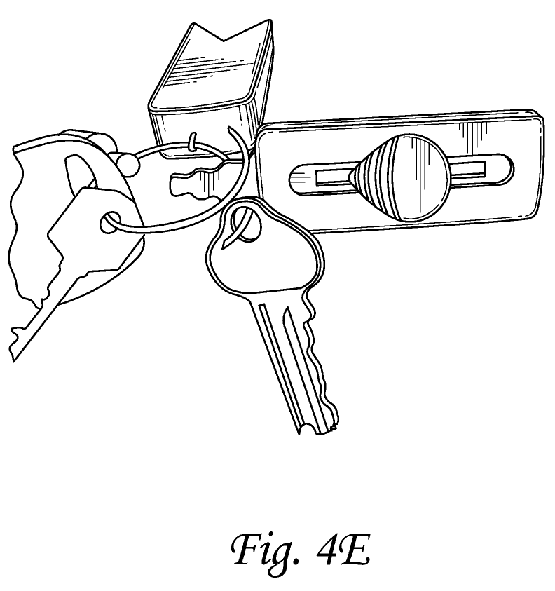

As shown in FIGS. 3A-3C, the blade member 15 has a distal end 19 opposite a proximal end 21 with an intermediate portion 23 therebetween. The distal end 19 has a generally wedge shape with a narrow distal tip 25 extending transverse to the translation axis 16 as best shown in FIGS. 3A and 3B. The intermediate portion 23 has first and second scalloped edges 27A, 27B on opposite sides of the intermediate portion 23. The scalloped edges 27A, 27B define respective sequences of peaks 29A, 29B and valleys 31A, 31B opposed to one another. The narrow distal tip 25 of the distal end 19 and the scalloped edges 27A, 27B of the intermediate portion 23 of the blade member 15 are adapted to separate and spread apart the split ring (FIGS. 4A-4E).

In the preferred embodiment, the opposed peaks 29A, 29B and valleys 31A, 31B of the scalloped edges 27A, 27B are offset from another in magnitude that increases as a function of distance from the distal end of the blade as shown in FIG. 3B. The scalloped edges 27A, 27B preferably define flat curved surfaces that are generally continuous without abrupt changes in curvature as best shown in FIG. 3A.

The blade member 15 translates along the predetermined translation axis 16 between a retracted position and an extended position. In the retracted position of the blade member 15, at least a major portion of the scalloped edges 27A, 27B of the intermediate portion 23 of the blade member are housed within the housing 13. In the preferred embodiment, the blade member 15 extends through the opening 18 of the housing 13 such that distal end 19 of the blade member 15 is disposed outside the housing 13 in the retracted position (FIG. 4A). In the extended position, the blade member 15 extends through the opening 18 of the housing 13 such that the scalloped edges 27A, 27B of the intermediate portion 23 are disposed outside the housing (FIG. 4D).

The housing 13 supports means for effectuating translation of the blade member 15 in response to user input. In the preferred embodiment, such means is realized by a slot 33 extending through the housing 13 parallel to the translation axis 16 of the blade member 15 as best shown in FIG. 1. A button 35 is disposed on the exterior of the housing 13 for hand manipulation by the user. A connector passes through the slot 33 and connects the button 35 to the blade member 15. In the preferred embodiment, the connector is realized by a locking post 37 that extends from the bottom surface of the button 35 and passes through and interlocks to a corresponding cut-out 39 in the proximal portion 21 of the blade member 15 by rotation of the post 37 relative to the blade member 15 as is evident from FIG. 2A. Manipulation of the button 35 by the user's hand (preferably by the thumb of the user) slides the button 35 distally to translate the blade member 15 toward its extended position. Such hand manipulation of the user can also slide the button 35 proximally to translate the blade member 15 toward its retracted position, thereby effectuating the translation of the blade member 15. In the preferred embodiment, the button 35 has a tear-drop shape with a tapered section pointing to the distal end 19 of the blade member 15. The top surface 37 of the button 35 can have ridges and grooves or other suitable non-skid features to aid the user in sliding the button 35 during operation.

The housing 13 defines a guide channel for guiding translation of the blade member 15 along the translation axis 16. In the preferred embodiment as best shown in FIGS. 2A and 3A, the proximal portion 21 of the blade member 15 has two side edges 41A, 41B that are disposed opposite one another and extend parallel to the translation axis 16. The guide channel of the housing is realized by two sidewalls 43A, 43B of the housing portion 13B that are disposed opposite one another and extend parallel to the translation axis 16 as shown in FIG. 2B. The sidewalls 43A, 43B interface to the side edges 41A, 41B of the proximal portion 21 of the blade member 21 to guide translation of the blade member 15 along the translation axis 16.

As shown in FIG. 1, the cap 17 preferably includes a through-hole structure 45 for connecting the cap 17 to a split ring, if desired (FIG. 4A). The cap 17 includes an opening 47 for receiving the housing 13 of the tool. In the preferred embodiment, the opening 47 is adapted to avoid covering the button 35 and interfaces to the button 35 when sliding the cap 17 over the housing 13 for translating the blade member 15 proximally to its retracted position as described above. When the blade member 15 is extended, the user only needs to slide the housing 13 into the cap 17 to retract the blade member 15. When completely retracted, the button 35 snaps securely in place. In addition, there may be additional incremental positions along the range of translation of the blade member 15 where the button 35 (or other structure) snaps into position.

In the preferred embodiment, the tool as described herein is assembled by inserting the locking post 37 of the button 35 through the slot 33 in the top housing portion 13A and interlocking the post 37 to the cut-out 39 of the blade member 15. The bottom housing portion 13B is snap fit to the top housing portion 13A with the blade member 15 supported in the guide channel provided by the tool housing 13. In this manner, the button 35, post 37, housing 13, and blade member 15 fit uniquely together for connecting and removing items from the split key ring holder.

The tool is used to separate and spread apart a split ring key holder as shown in FIGS. 4A-4E. The user removes the housing 13 from the cap 17, if need be as shown in FIG. 4A. The user then inserts the distal tip 25 of the blade member 15 between the spiral member portions of the split ring as shown in FIG. 4B. Such operations provide initial separation of the split ring. The user then adjusts the position of the blade member 15 such that the spiral member portions of the split ring overlie opposed valleys 31A, 31B of the scalloped edges 27A, 27B of the blade member as desired as shown in FIG. 4C, and then rotates the tool such that the spiral member portions of the split ring rest in the opposed valleys 31A, 31B of the scalloped edges 27A, 27B as shown in FIG. 4D. Such rotation spreads apart the spiral member portions of the split ring for threading a key onto the key ring as shown in FIG. 4E. The dimensions between the opposed valleys 31A, 31B of the scalloped edges 27A, 27B graduate to provide a range of separation magnitude. The scalloped edges 27A, 27B of the blade member 15 are preferably flat to keep the blade member 15 in place while the spiral member portions of the split ring are spread apart.

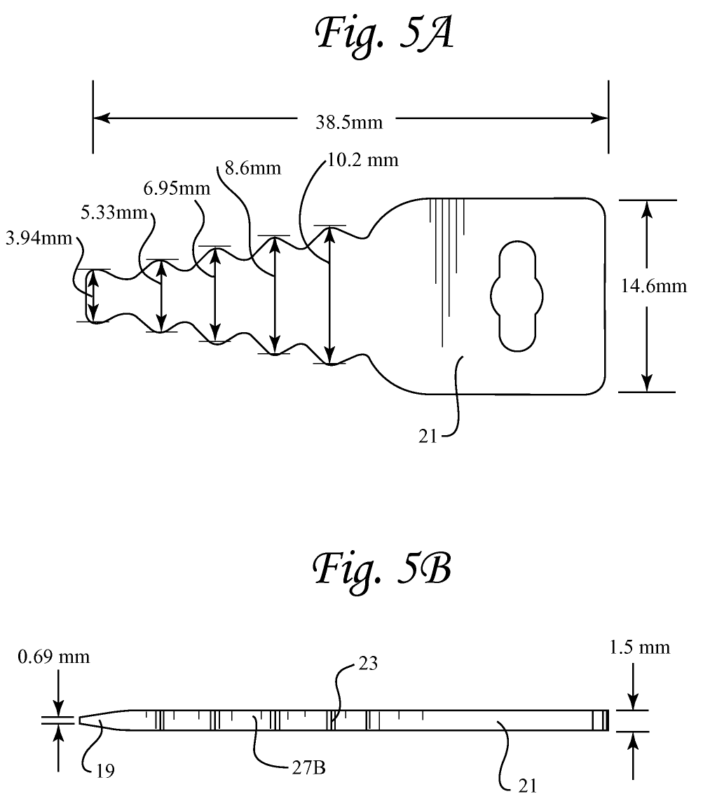

FIGS. 5A and 5B illustrate exemplary dimensions of the blade member in accordance with a preferred embodiment of the invention. In this embodiment, the blade member 15 is 38.5 mm in length. The proximal portion 21 of the blade member 15 is 14.6 mm wide. The distal portion 19 of the blade member 15 has a maximal width of 3.94 mm. The distal tip 25 of the blade member 15 has a thickness of 0.69 mm. The distal portion tapers from the distal tip thickness of 0.69 mm to 1.5 mm thickness for the intermediate and proximal portions of the blade member 15. The offsets between the opposing peaks of the scalloped edges of the intermediate portion of the blade member 15 graduate in size with distance from the distal tip 25 with offsets of 5.33 mm, 6.95 mm, 8.6 mm and 10.2 mm for the sequence of four peak pairs as shown. The dimensions depicted in FIGS. 5A and 5B are illustrative in nature and can be varied by design as desired.

Advantageously, the tool of the present invention as described herein allows the user to effectively and efficiently separate and spread apart a split ring key holder for connecting and removing items from the split key ring holder. For example, the wedge-shaped distal tip of the retractable blade member slides easily between the adjacent helical sections of the split ring key holder in order to initially separate such helical sections. The scalloped structure of the edges of the blade member allows the user to keep the blade secure while providing the ability to spread ring to any desired opening. The flat surfaces of the scalloped edges employed in the preferred embodiment keeps the blade member in place while the blade is rotated and the helical sections of the split ring key holder is spread. The retractable nature of the blade together with the cap that covers the tool housing allows the blade to be stored in a retracted position while not in use, which provides for safety and limits interference of the tool with other items. The tool can be used to connect and remove items from the split key ring holder and avoid prying open the slit ring key holder with a fingernail, which can harm the fingernail itself or the soft tissue under the fingernail.

There have been described and illustrated herein several embodiments of a tool for separating and spreading apart a split ring key holder and a method of using said tool. While particular embodiments of the invention have been described, it is not intended that the invention be limited thereto, as it is intended that the invention be as broad in scope as the art will allow and that the specification be read likewise. Thus, while particular mechanisms for guided translation of the retractable blade member have been disclosed, it will be appreciated that other suitable mechanisms for guided translation of the retractable blade member can be used as well. In addition, while particular structural features and shapes of the housing, cap and blade member of the tool have been disclosed, it will be understood that other structures and shapes can be used to realize these elements. Moreover, while particular retractable blade configurations have been disclosed, it will be appreciated that other non-retractable blade configurations could be used as well. It will therefore be appreciated by those skilled in the art that yet other modifications could be made to the provided invention without deviating from its spirit and scope as claimed.

What is claimed is:

1. An apparatus for connecting items to and from a split ring, said apparatus comprising:
a housing supporting a blade that translates along a predetermined translation axis between a retracted position and an extended position, the blade having a distal end opposite a proximal end with an intermediate portion therebetween, the distal end having a generally wedge shape with a narrow distal tip extending transverse to the predetermined translation axis, and the intermediate portion having first and second scalloped edges on opposite sides of the intermediate portion, the first and second scalloped edges defining respective sequences of peaks and valleys opposed to one another, wherein the narrow distal tip of the distal end of the blade and the first and second scalloped edges of the intermediate portion of the blade are adapted to separate and spread apart the split ring.

2. The apparatus of claim 1, wherein:
the opposed peaks and valleys of the first and second scalloped edges are offset from another in magnitude that increases as a function of distance from the distal end of the blade.

3. The apparatus of claim 1, wherein:
the first and second scalloped edges define flat curved surfaces that are generally continuous without abrupt changes in curvature.

4. The apparatus of claim 1, wherein:
in the retracted position of the blade, at least a portion of the scalloped edges of the intermediate portion of the blade are housed within the housing.

5. The apparatus of claim 1, wherein:
in the retracted position of the blade, the distal end of the blade is disposed outside the housing.

6. The apparatus of claim 1, wherein:
in the extended position, the scalloped edges of the intermediate portion of the blade are disposed outside the housing.

7. The apparatus of claim 1, wherein:
the housing supports means for effectuating translation of the blade in response to user input.

8. The apparatus of claim 7, wherein:
the means for effectuating translation of the blade comprises a slot extending through housing parallel to the predetermined translation axis of the blade, a button disposed on the exterior of the housing for hand manipulation by the user, and a connector that passes through the slot and connects the button to the blade, whereby the hand manipulation of the button effectuates translation of the blade.

9. The apparatus of claim 8, wherein:
the button has a tear-drop shape with a tapered section pointing to the distal end of the blade.

10. The apparatus of claim 8, wherein:
the connector includes a post that engages and locks to a corresponding cut-out in the proximal portion of the blade.

11. The apparatus of claim 1, wherein:
the housing defines a guide channel for guiding translation of the blade along the predetermined translation axis.

12. The apparatus of claim 1, wherein:
the proximal portion of the blade has two side edges disposed opposite one another and extending parallel to the predetermined translation axis, and the guide channel of the housing includes two sidewalls disposed opposite one another and extending parallel to the predetermined translation axis, the two sidewalls interfacing to the two side edges of the proximal portion of the blade to thereby guide translation of the blade along the predetermined translation axis.

13. The apparatus of claim 1, further comprising:
a cap separate and distinct from the housing for surrounding at least a part of the housing in a tight-fit manner such that the housing is removably secured within the cap, wherein the cap includes a through-hole structure for connecting the cap to a split ring.

14. The apparatus of claim 13, wherein:
the housing supports a button disposed on the exterior of the housing for hand manipulation by the user, and the cap includes an opening for receiving the housing, the opening adapted to avoid covering the button.

15. The apparatus of claim 14, wherein:
the button has a tear-drop shape with a tapered section pointing to the distal end of the blade, and the opening of the cap is defined by a triangular-shaped cutout that avoids covering the button.

16. The apparatus of claim 14, wherein:
the opening of the cap is adapted to provide for securing the button in a fixed position whereby the blade rests in its retracted position.

17. An apparatus for connecting items to and from a split ring, said apparatus comprising:
an elongate blade having a distal end opposite a proximal end with an intermediate portion therebetween, the distal end having a generally wedge shape with a narrow distal tip extending transverse to the longitudinal axis of the blade, and the intermediate portion having first and second scalloped edges on opposite sides of the intermediate portion, the first and second scalloped edges defining respective sequences of peaks and valleys opposed to one another, wherein the narrow distal tip of the distal end of the blade and the first and second scalloped edges of the intermediate portion of the blade are adapted to separate and spread apart the split ring.

18. The apparatus of claim 17, wherein:
the opposed peaks and valleys of the first and second scalloped edges are offset from another in magnitude that increases as a function of distance from the distal end of the blade.

19. The apparatus of claim 17, wherein:
the first and second scalloped edges define flat curved surfaces that are generally continuous without abrupt changes in curvature.
